(19) United States
(12) Patent Application Publication
(10) Pub. No.: US 2021/0272110 A1
(43) Pub. Date: Sep. 2, 2021

(54) PSEUDONYMOUS FIAT CURRENCY TRANSACTION LOGGER SYSTEM AND METHOD FOR PAYMENT GATEWAYS

(71) Applicant: Jakub Tomasz Ner, Sammamish, WA (US)

(72) Inventor: Jakub Tomasz Ner, Sammamish, WA (US)

(21) Appl. No.: 16/805,831

(22) Filed: Mar. 2, 2020

(51) Int. Cl. G06Q 20/38; H04L 9/06

(52) U.S. Cl. CPC G06Q 20/3829; H04L 2209/38; H04L 9/0637; G06Q 20/389

(57) ABSTRACT

The present invention relates to a method of recording an anonymized fiat currency transaction between service provider (“payee”) and customer (“payer”) facilitated by a third party payment gateway in a publicly available ledger with a unique set of data points from all parties involved (“payer”, “payee”), which enables software developers to implement an innovative ledger-based service authorization workflow for payments while reducing the software developers burden to store end user sensitive information.

### FIELD OF THE INVENTION

The invention relates generally to pseudonymous fiat currency transaction logger system and method for payment gateways.

### BACKGROUND

In today's online commerce ecosystem to use an on-line service, a customer creates an account and provides personal data. Establishing this identity is necessary in order to charge a customer for a service.

### SUMMARY OF THE INVENTION

Service providers executing service authorization workflows control personally identifiable information in private ledgers and thus there is no opportunity for any anonymization of the parties involved in the fiat currency transaction. Thus, industry solutions are unable to deliver a system that records an anonymized fiat currency transaction between service provider (“payee”) and customer (“payer”) in a public ledger which absolves on-line service providers from the responsibility of storing sensitive payment and personal information when they wish to enable service authorization workflows for their customers to access services.

It would be desirable to have a system that absolves on-line service providers from the responsibility of storing sensitive payment and personal information when they wish to enable service authorization workflows for their customer login process to their network hosted services. Furthermore, there is a need for a single remuneration validating approach that is suitable for use in any country and with any type of currency—including crypto-currencies—enabling on-boarding of service providers and their customers into the benefits of currency type flexibility. Therefore, there currently exists a need in the industry for a system for recording anonymized fiat currency transaction between service providers and customers.

The process to log pseudonymous fiat currency transactions on a public ledger between customer (“payer”) and service provider (“payee”) in order to improve service authorization workflows has fundamental concepts and requirements for the desired outcome to be achieved.

The first requirement is related to the cryptographic anonymized addresses that both the payee and payer provide to the process in order to ensure logged transactions remain pseudonymous. The cryptographic anonymized addresses are each a byte string that is borrowed from a plurality of public-key infrastructures, such as any public blockchain ledger. The significance of these cryptographic anonymized addresses is that each address has a corresponding private secret key for signing some message into signatures; that equates possession of the secret key to ownership of the public address.

The second set of requirements is related to the three systems that the process depends on to complete the recording of an anonymized fiat currency transaction in a public ledger, they are:

a) Service provider online service which initiates the customer authentication and authorization workflows that trigger the process. Service provider may be registered with the system hosting the process as described in section (c) below.

b) Third party payment gateways that the process communicates with to execute the fiat currency payment between payee and payer.

c) The system that is hosting the process on the network providing computation and storage services required to facilitate process execution and logging of the final transaction in a public ledger.

With the assumption that all of the above requirements are met, the process may execute through the following steps to record an anonymized fiat currency transaction in a public ledger.

1. Customer authenticates with Service Provider's system using their cryptographic anonymized address.

2. Service provider initiates authorization check with a public ledger to verify that the anonymized address exists on the ledger with associated payment details.

3. If verified, customer is granted access to services. If not verified, customer agrees to purchase services from service provider for a specified monetary amount.

4. Payment is processed with a third party payment gateway and if successful a transaction ledger entry is recorded.

At the conclusion of the steps outlined above the transaction's details captured in the public ledger are: service provider anonymized address, customer anonymized address, amount paid by customer, time stamp when transaction occurred.

The current process supports recording of anonymized fiat currency transactions between service provider (“payee”) and customer (“payer”), furthermore the process may be expanded to support any other fiat currency in the world. Specifically, the process may be integrated with third party payment gateways processing transactions in currencies from any country. In the case where the process is expanded to support other fiat currency types, the system may provide a publicly available ledger for each currency type. The process enables a public ledger-based authorization workflow to now work with fiat currencies, as it is already implicitly compatible to work with any anonymized blockchain crypto-currency transactions between service provider (“payee”) and customer (“payer”). The public ledger-based authorization workflow—stemming from the process—may be further expanded to support any public blockchain crypto-currency.

This disclosure will now provide a more detailed and specific description that will refer to the example accompanying drawings. The drawings and specific descriptions of the drawings, as well as any specific or alternative embodiments discussed, are intended to be read in conjunction with the entirety of this disclosure. The Pseudonymous Fiat Currency Transaction Logger System and Method for Payment Gateways may, however, be embodied in many different forms and should not be construed as being limited to the embodiments set forth herein; rather, these embodiments are provided by way of illustration or example only so as to convey understanding to those skilled in the art.

### BRIEF DESCRIPTION OF THE DRAWINGS

Preferred embodiments of the present invention will now be described, by way of example only, with reference to the attached FIGURES, wherein:

FIG. 1. is a sequence flow depicting the method of logging an anonymized fiat currency transaction between a service provider (payee) and customer (payer) facilitated by a third party payment gateway in a publicly available ledger

### DETAILED DESCRIPTION

The present invention is directed to pseudonymous fiat currency transaction logger system and method for payment gateways.

The process below enables absolving online commerce service providers from handling sensitive customer information and improving service authorization workflows across any currency (fiat or crypto) and country.

The process implements a logger for anonymized transactions between a service provider (“payee”) and customer (“payer”) in fiat currencies, so as to enable ledger-based authorization workflows matching approaches possible and implied with crypto currencies. With fiat currencies the transactions are facilitated by a third party payment gateway. With crypto-currencies the transactions are facilitated by public blockchains. The process logged output is stored in a public ledger, one ledger per fiat currency type is made available to service providers and their system developers to improve service authorization workflows during and after customer login to access online services.

In order to carry out this process the following core steps are followed:

1. Customer authenticates with Service Provider's system using their cryptographic anonymized address.

2. Service provider initiates authorization check with a public ledger to verify that the anonymized address exists on the ledger with associated payment details.

3. If verified, customer is granted access to services. If not verified, customer agrees to purchase services from service provider for a specified monetary or crypto-currency amount.

4. Payment is processed with third party payment gateway or third party public blockchain depending on currency type and if successful a transaction ledger entry is recorded.

At the conclusion of the steps outlined above the transaction's details captured in the public ledger are: service provider anonymized address, customer anonymized address, amount paid by customer, time stamp when transaction occurred

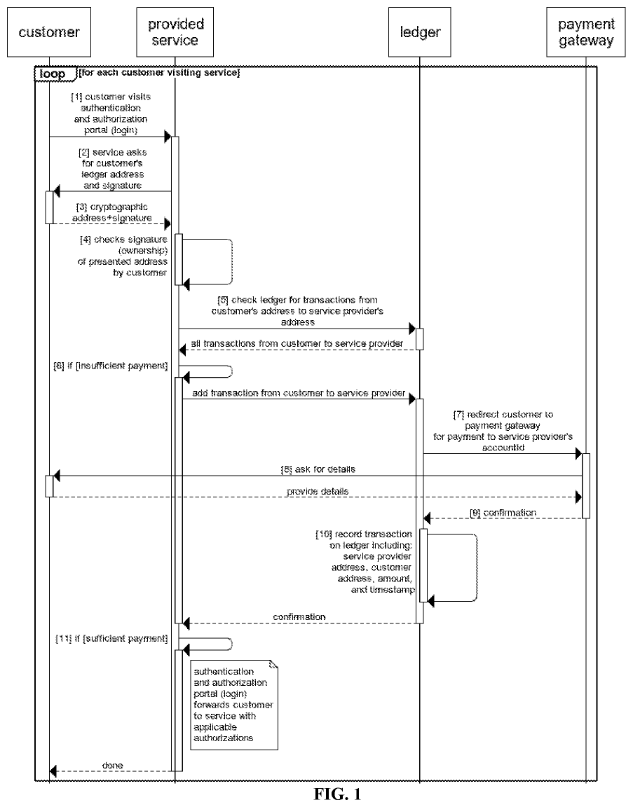

FIG. 1—Steps 1 through 4: Customer authenticates with Service Provider's system using their cryptographic anonymized address.

FIG. 1—Step 5: Service provider initiates authorization check with public ledger to verify anonymized address exists on ledger with associated payment details.

FIG. 1—Step 6: If verified, customer is granted access to services with applicable authorizations. If not verified, customer agrees to purchase services from service provider for a specified monetary amount.

FIG. 1—Steps 7 through 9: Customer is re-directed to complete payment with third party payment gateway.

FIG. 1—Step 10: Once payment confirmation received, the public ledger entry is recorded.

FIG. 1—Step 11: Customer is forwarded to services with applicable authorizations

The disclosed method is unique when compared with other known processes and solutions in that our functional focus is on anonymizing the parties (“payer”, “payee”) in each fiat ledger transaction where the parties involved control the anonymization function. This enables us to expose ledger entries publicly without sacrificing parties' privacy. Since the parties control the anonymizing function, they may later prove their involvement in ledger transactions at time of dereferencing the ledger—time of service authorization.

From a structural point of view the system produces ledger entries that are syntactically similar to ledger output of crypto-currency systems, but semantically tied to fiat currencies. Each ledger entry is comprised of:
service provider anonymized address
customer anonymized address
amount paid by customer
time stamp when transaction occurred

The “addresses” (above) are fundamentally different from fiat ledgers as they do not identify entities involved in each transaction but—through cryptography—enable entities to prove their participation in the transaction at any time after the transaction was written into the ledger.

The “amount” (above) is fundamentally different from crypto currency ledgers as it represents a fiat currency transaction.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. The person of skill in the art will understand that modifications, variations and other embodiments may be covered by this disclosure. It is indeed intended that the scope of this disclosure should be determined by a proper legal interpretation of the disclosure, including equivalents, as understood by those of skill in the art relying upon the complete disclosure present at the time of filing.

I claim:

1. A computer system process to log pseudonymous fiat currency transactions on a public ledger between customer (“payer”) and service provider (“payee”) for the purpose of authorization workflows.
The public ledger of claim 1, viewed as a series of data-structure records, each consisting of a service provider anonymized address, a customer anonymized address, an amount paid by customer, and a time stamp when transaction occurred.
The service provider anonymized address of claim 2 is a byte string that is generated by any algorithm from a plurality of public-key infrastructures, such as any public blockchain ledger.
The service provider anonymized address of claim 2 is publicly published on the public ledger of claim 1.
The service provider anonymized address of claim 2, wherein each address has a corresponding private secret key, generated by a corresponding algorithm from the public-key infrastructures of claim 3 for signing some message into signatures; that equates possession of the secret key to ownership of the public address.
The customer anonymized address of claim 2 is a byte string that is generated by any algorithm from a plurality of public-key infrastructures, such as any public blockchain ledger.
The customer anonymized address of claim 2 is publicly published on the public ledger of claim 1.
The customer anonymized address of claim 2, wherein each address has a corresponding private secret key, generated by a corresponding algorithm from the public-key infrastructures of claim 6 for signing some message into signatures; that equates possession of the secret key to ownership of the public address.
The process of claim 1 executes via a computer system that hosts the process on a network, whereby the computer system provides computation and storage services required to facilitate process execution and logging of data-structure records as per claim 2 in a public ledger.
The fiat currency transactions between payee and payer of claim 1 are executed via a plurality of third party payment gateways that the process of claim 1 communicates with, whereby the payment gateways are external to the process and their involvement in the process is controlled by the computer system in claim 9.
The third party payment gateways of claim 10 are responsible for the value transfer from customers to service providers in a manner particular to each payment gateway, whereby each customer and each service provider is onboarded onto each payment gateway in said payment gateway's specific way, and each customer and each service provider entrusts said payment gateway for the purposes of the value transfer.
The computer system of claim 9 is able to interrogate the payment gateways of claim 10 to identify the payee, the payer, the value transfer amount, and transaction timestamp, in a payment gateway specific way.
The computer system of claim 9 is able to reconcile the payee of claim 10 to the service provider anonymized address for the purposes of recording on the public ledger.
The computer system of claim 9 is able to reconcile to payer of claim 10 to the customer anonymized address for the purposed of recording on the public ledger.
The computer system of claim 9 records into the public ledger the value transfer amount as per claim 12, the timestamp as per claim 12, the service provider anonymized address as per claim 13, the customer anonymized address as per claim 14, whereby this write constitutes a transaction data-structure record in the public ledger.
The process of claim 1 includes a plurality of authorization workflows wherein a plurality of service provider online services execute customer authorizations.
The authorization workflows of claim 16 start with customers authenticating their identity wherein presenting their customer anonymized address and a corresponding signature as per claim 8, whereby the service provider can check the customer anonymized address and the signature with a corresponding algorithm from a corresponding public-key infrastructure to verify the customer's identity.
The authorization workflows of claim 16 comprise an authorization check with a public ledger to verify that a record exists whereby the customer anonymized address is recorded as paying requisite value transfer amount to the service provider anonymized address within a required timeframe.
The required checks in claim 18, whereby service provider specific service access requirements are checked against public ledger record values including a customer anonymized address, service provider anonymized address, value transfer amount, and a timestamp, constitute the necessary checks to finish the authorization workflow as per the process in claim 1.
